(19) United States
(12) Patent Application Publication
(10) Pub. No.: US 2007/0257054 A1
(43) Pub. Date: Nov. 8, 2007

(54) Delivery Control for Vending Machine

(76) Inventors: Jurgen Obermeier, Hullhorst (DE); Norbert Wolf, Lubbecke (DE); Volker Pahmeyer, Oeynhausen (DE)

Correspondence Address: NEIL STEINBERG, 2300 M STREET, N.W., WASHINGTON, DC, 20037, US

(21) Appl. No.: 11/662,807

(22) PCT Filed: Oct. 20, 2005
(86) PCT No.: PCT/EP05/11268

§ 371 Date: Mar. 13, 2005

(30) Foreign Application Priority Data
Feb. 12, 2005 (DE) 10 2005 006 473.6

(51) Int. Cl. G07F 11/42

(52) U.S. Cl. 221/209; 700/15

(57) ABSTRACT

The invention relates to a vending machine comprising a plurality of merchandise compartments (10) arranged one above the other, a dispensing means (18, 102) for each merchandise compartment (10), which, when activated, dispenses an item of merchandise from the merchandise compartment (10), at least one transport mechanism (20) that can be driven by drive means (26, 28, 30, 32, 103) and which transports the items of merchandise dispensed by the dispensing means (18) to a removal position by means of a removal tray (22). The vending machine has an electronic control and memory unit (101) for controlling the transport mechanism (20) in order to move the removal tray (22) to a desired position in front of the respective activated merchandise compartment (10) to receive an item of merchandise, and subsequently into the merchandise dispensing region (6) and the removal position for removal of the item of merchandise. The electronic control and memory unit (101) is configured to detect and store a blockage position from which, before reaching the desired position, the removal tray (22) cannot be moved further in the direction of the desired position.

The invention relates to a vending machine comprising a plurality of merchandise compartments arranged one above the other, a dispensing means for each merchandise compartment which, when activated, dispenses an item of merchandise from the merchandise compartment, at least one transport mechanism that can be driven by drive means and which transports the items of merchandise dispensed by the dispensing means to a removal position by means of a removal tray. The vending machine has an electronic control and memory unit for controlling the transport mechanism in order to move the removal tray to a desired position in front of the respective activated merchandise compartment to receive an item of merchandise, and subsequently into the merchandise dispensing region and the removal position for removal of the item of merchandise. The invention also relates to a method for operating a vending machine that includes a transport mechanism.

A vending machine for dispensing bottles or cans and having a plurality of merchandise compartments arranged one above the other and tilted in the direction of a respectively allocated transfer position is known from European patent application 0 071 438 A2. A transport mechanism moves a merchandise carrier. When requested, the merchandise carrier can receive an item of merchandise from a merchandise compartment at the respective transfer position. The item of merchandise is moved by means of the transport mechanism to a transfer position in an upper section of the vending machine, where the item of merchandise rolls into a removal compartment, ready for removal by a customer. This known vending machine is complex in structure.

A vending machine with a transport mechanism is disclosed in the laid-open patent specification DE 199 46 609 A1. In this known vending machine, the transport mechanism is disposed between the front wall of the vending machine and the merchandise compartment. A removal tray is moved by means of the drive unit to a receiving position or desired position in front of the respective activated merchandise compartment and subsequently into the merchandise dispensing region and the removal position.

The front wall of such vending machines is configured as a door, for example, and the transport mechanism is fixed to the inner surface of the door by means of fixing elements. The transport mechanism is therefore particularly simple to access, for example for maintenance purposes.

The transport mechanism typically contains transmission elements on which the removal tray can be moved. The transmission elements form endless loops, for example, which run over upper and lower deflection elements and drive elements. The removal tray is fixed to the transmission elements by means of fixing elements. The fixing elements with which the removal tray is fixed to the transmission elements can be slideably guided in lateral guide rails. The transmission elements are configured as endless toothed belts. Transport of the removal tray can be performed and controlled in a particularly precise manner with the endless toothed belts guided in the lateral guide rails.

The transport mechanism contains the drive elements, a drive shaft for driving the drive elements, and a transport drive motor for driving the drive shaft and the deflection elements.

The front wall is embodied as a door and is pivotably mounted to a fixed side wall of the vending machine. The front wall is mostly embodied as a viewing window, with a removal opening being disposed below the viewing window. The transmission elements, the deflection elements, the drive elements, the drive shaft and the drive unit are disposed behind the mounting for the viewing window. In this way, the items of merchandise stored in the merchandise compartments can be viewed from the outside through the transparent front pane, and the drive elements are covered from view by a screen providing protection from external view due to their being disposed behind the mounting of the viewing window. On viewing the vending machine, a customer is therefore stimulated to purchase the items of merchandise on offer.

In this type of vending machine, a plurality of merchandise compartments that can each be filled with different items of merchandise are arranged adjacent each other and form a horizontal group of merchandise compartments. Several groups of merchandise compartments are arranged in a spaced-apart manner one above the other. The removal tray of the transport mechanism extends across the entire horizontal width of the group of merchandise compartments. Thus, the items of merchandise dispensed from one of the adjacently arranged merchandise compartments are each transferred to the removal tray without the removal tray being moved horizontally.

The vending machines have locking means which hold a removal flap in front of the removal opening in a closed position and which releases the removal flap for opening only when the removal tray has reached the removal position in which the user can remove the item of merchandise from the removal tray through the removal opening. This prevents any theft of merchandise during operation of the transport mechanism.

The object of the invention is to provide a vending machine that has a better structure and which operates better than prior art vending machines when dispensing merchandise.

This object is accomplished pursuant to the invention by a vending machine according to claim 1 and a method according to claim 11.

The electronic control and memory unit of a vending machine according to the invention is preferably configured to detect and store a blockage position from which, before reaching the desired position, the removal tray cannot be moved further in the direction of the desired position. In conventional vending machines, problems occur as a result of the vending machine being badly filled, for example, or due to subsequent slippage of the items of merchandise. Items of merchandise which are not in the proper position can block the removal tray when it is moved to a desired position where the removal tray is to receive an item of merchandise from an activated merchandise compartment. This is the case, for example, when an item of merchandise or the packaging of an item protrudes from a merchandise compartment. In conventional vending machines, such a blockage leads to the vending machine becoming non-operational. In contrast, the vending machine according to the invention is able to detect and store a blockage position by means of the electronic control and memory unit, which enables it to handle a blockage in the present and in future sale procedures without the vending machine according to the invention having to go completely out of operation. It thus remains possible, under certain conditions, to sell items of merchandise without the vending machine having to be subjected immediately to complicated maintenance.

The vending machine according to the invention preferably has position control means for generating a position signal corresponding to an actual position of the removal tray. Basically there are different possibilities for determining the position of the removal tray during a sale procedure. On the one hand, this can be done on the basis of the movements and forces within the transport mechanism and by means of the drive means. On the other hand, it is also possible to dispose position control means inside the vending machine that provide additional position information. The position control means can be a photoelectric barrier, for example, or a similar device that communicates to the electronic control and memory unit whether a desired actual position has been reached. Such additional position control means have the particular advantage that an independent position signal or independent position information is provided that is not derived solely from the relative movements and forces of the transport mechanism and the drive means.

It is likewise preferred that the electronic control and memory unit (101) be configured to detect a timeout in the event that the removal tray does not reach a predefined actual position when moving to the desired position. This additionally prevents the transport mechanism from being exposed to unpermittedly high load levels in the event of a blockage. According to this preferred embodiment, the electronic control and memory unit has means for determining not only the blockage position itself, but also one or more actual positions when moving in the direction of the desired position. The electronic control and memory unit can derive the blockage position from these actual positions, for example. If movement with the removal tray towards a desired position does not succeed, such movement is permitted only for a specific time interval or until a time limit has been exceeded. As soon as the time limit has been reached, a special routine relating to the presence of a blockage position is performed by the electronic control and memory unit. This makes it possible to identify deviations from the normal movement and to respond accordingly, even while the removal tray is approaching the desired position. Blockages can thus be detected earlier in the procedure.

It is further preferred that the control and memory unit be configured to perform at least one second attempt to move the removal tray to the desired position, in the event that a timeout was detected in the respective preceding attempt. This preferred configuration of the control and memory unit addresses the fact that when moving towards a blockage, the blockage may be undone by the removal tray in certain circumstances. By making an additional attempt, it may then be possible to reach the desired position after all, i.e. the activated merchandise compartment, even though this was not possible initially when making the first attempt.

The control and memory unit is preferably configured to record the number of attempts in which a timeout was detected. This means it is possible to permit any number of attempts to move the removal tray, and that the procedure is not discontinued, or special treatment performed, until the defined number of attempts has been carried out with no success. A favorable number of attempts to move the tray can be determined empirically, for example, or may derive from practical considerations.

The control and memory unit preferably ends the sales procedure when a predefined number of more than two timed-out attempts has been reached. The latter is a practicable value that does not involve too much waiting on the part of the customer who is waiting for the item of merchandise to be dispensed, while nevertheless permitting a reasonable number of attempts to dispense the merchandise after all.

The control and memory unit of a vending machine according to the invention can preferably take into account, during a second, subsequent sale attempt, the blockage position identified and stored during a first sale attempt. This can take the form, for example, of no longer offering merchandise for sale from an unreachable merchandise compartment located beyond a blockage. Items of merchandise that can still be reached by the removal tray despite the blockage, because they are located in front of the blockage, can continue to be sold. In contrast to the prior art, a vending machine according to the invention is not rendered completely inoperable as a result of a blockage, but remains operational for at least some of the merchandise.

According to another embodiment of the electronic control and memory unit, the blockage position identified and stored during a first sale attempt is taken into consideration during a second, subsequent sale attempt in yet another way. In this case, even merchandise located at a desired position beyond the blockage are offered for sale if the merchandise can be transferred to the removal tray despite the blockage. There can be various criteria for this to occur. One criterion can be that the merchandise is not damaged if it falls into the removal tray from a merchandise compartment located high up in the vending machine. However, an item of merchandise that is too sensitive or unsuitable for transfer is not transferred to the removal tray in this embodiment, either. This aspect of the invention enables an even greater proportion of the merchandise to be sold despite the blockage position.

A vending machine according to the invention preferably has a plurality of merchandise compartments arranged adjacent each other and which collectively form a horizontal group of merchandise compartments. These groups of merchandise compartments may also be arranged in a spaced-apart manner one above the other, thus forming a kind of storeys. The removal tray can then extend preferably across the entire horizontal width of a compartment group, such that the items of merchandise of all merchandise compartments belonging to a group of merchandise compartments (i.e., to a storey) can be dispensed to the removal tray at a single desired position of the removal tray. This preferred embodiment enables the items of merchandise to be dispensed in a particularly rational manner, as well as simple assembly of the entire vending machine, including the transport mechanism, the drive means and the control and memory unit.

The invention also relates to a method for operating a vending machine comprising a plurality of merchandise compartments (arranged one above the other, a dispensing means for each merchandise compartment, which, when activated, dispenses merchandise from the merchandise compartment, at least one transport mechanism which transports the items of merchandise dispensed by the dispensing means to a removal position by means of a removal tray. The vending machine has an electronic control and memory unit for controlling the transport mechanism in order to move the removal tray to a desired position in front of the respective activated merchandise compartment to receive an item of merchandise, and subsequently into the merchandise dispensing region and the removal position for removal of the item of merchandise. In the method according to the invention, a blockage position is preferably detected and stored from which, before reaching the desired position, the removal tray cannot be moved further in the direction of the desired position. The advantages of the method according to the invention have already been described in the foregoing in relation to a vending machine according to the invention. A position signal corresponding to an actual position of the removal tray is preferably generated. It is likewise preferred that a timeout be detected in the event that the removal tray does not reach a predefined actual position when moving to the desired position. In the event that the actual position is not reached and the time limit is exceeded, another attempt is made to reach the desired position with the removal tray, and the number of attempts in which a timeout was detected is determined. The sale procedure is terminated when a predefined number of more than two timed-out attempts has been reached. There may, of course, be other numbers of attempts that are more favorable in specific cases and which must be carried out before the sale procedure is terminated. For example, it may be practicable not to perform any additional attempt, or just one single extra attempt, or a much greater number of attempts.

It is likewise envisaged that the path traveled by the removal tray until it performs a new attempt can practically be as small as desired. The removal tray initially travels from the blockage position to a neutral position at a small or large desired distance from the blockage position and subsequently moves back toward the blockage again. Each renewed movement toward the blockage is counted as one attempt.

The blockage position is preferably stored and taken into account in a second, subsequent attempt to effect a sale. It is then displayed to the customer that a particular item of merchandise that the customer has requested is no longer available. The definition of which items of merchandise can still be dispensed and which can not is made by the control and memory unit on the basis of the blockage position. This procedure, too, has been explained in the foregoing. Finally, the control and memory unit can also take the blockage position into account in a special routine or in a form of special treatment, by continuing to dispense items of merchandise from merchandise compartments that can actually no longer be reached due to the blockage, provided that these items are suitable for dispensing.

It is also possible that attempts be made in subsequent sale procedures to reach the desired position, in order to remove the blockage with the removal tray. This can be carried out routinely, or not until a customer has made a request.

In summary, a sequential controller according to the invention can effect the following procedures: Three attempts, for example, are made to reach the selected desired position. If these are unsuccessful, the position of the blockage is stored in the controller. Since the sales transaction was not carried out, the customer retains his credit in the machine and can either request that the money be returned, or choose a different item of merchandise. Sales are made quite normally in the case of future choices of merchandise items that are located ahead of the blockage position, since the respective positions of the merchandise compartments and hence the desired position can be reached. Positions of the removal tray beyond the blockage position can no longer be selected and result for the customer in a message such as “Please make a different selection” being displayed. The customer now has the choice of either asking for his money to be returned, or making a different selection. In addition, special treatment can be provided on the basis of which the operator can always release certain merchandise selections in service mode, even when a blockage exists. In this way, he can preferably designate products that can survive drops from greater heights without incurring damage. Even when there is a blockage ahead of the merchandise location, a merchandise selection released in this manner can still be purchased by the removal tray being moved to just below the blockage position, the item of merchandise being dispensed from a merchandise compartment located higher up the machine, and the sales operation then being executed in the normal manner.

An embodiment and the use of the invention shall now be explained in greater detail with reference to the drawings, in which

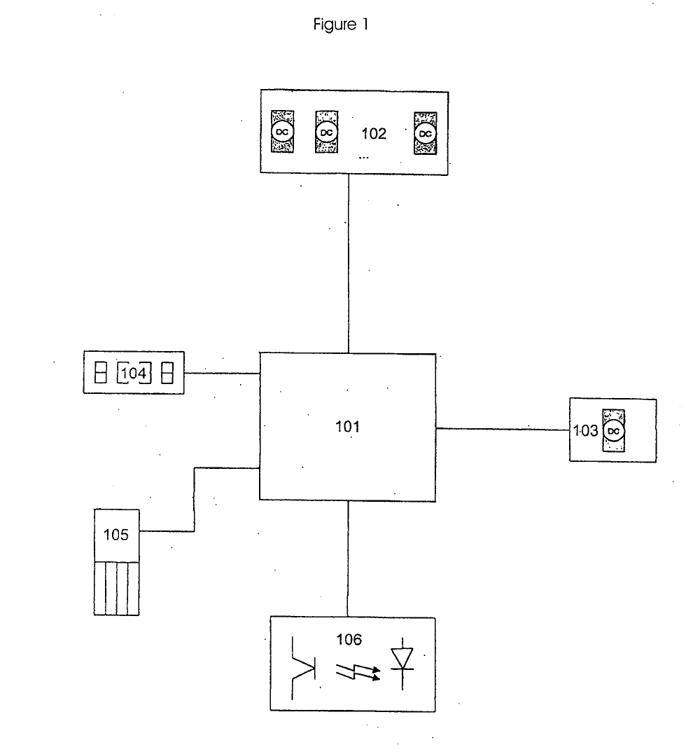

FIG. 1 shows a schematic block diagram of the main components of a vending machine according to the invention that are relevant for a preferred embodiment of the invention,

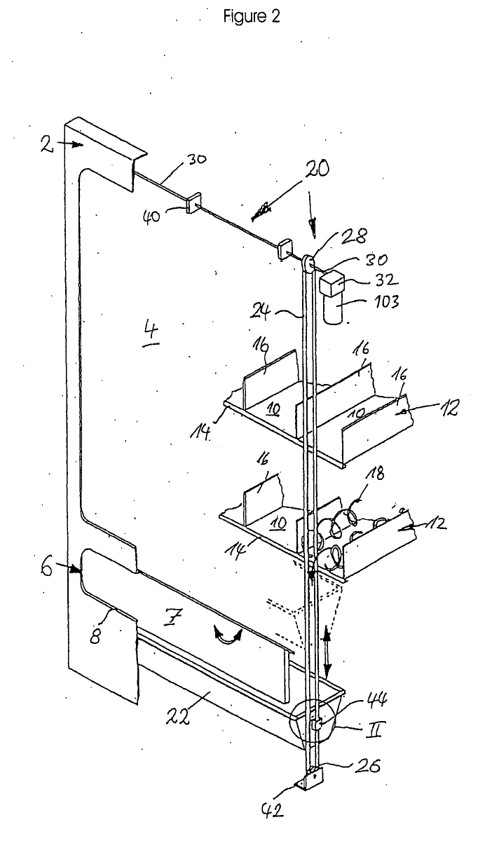

FIG. 2 shows a perspective sectional view of part of a conventional vending machine that includes a transport mechanism,

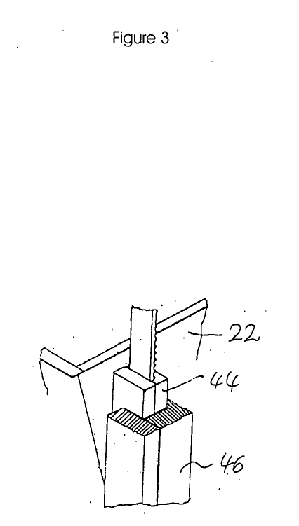

FIG. 3 shows a perspective detailed view of a transmission element of the known transport mechanism,

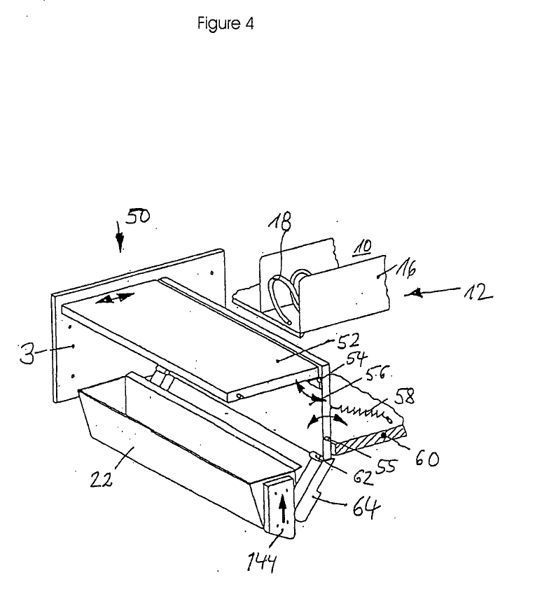

FIG. 4 shows a perspective view of a lower section in the known vending machine, with a removal tray in a removal position,

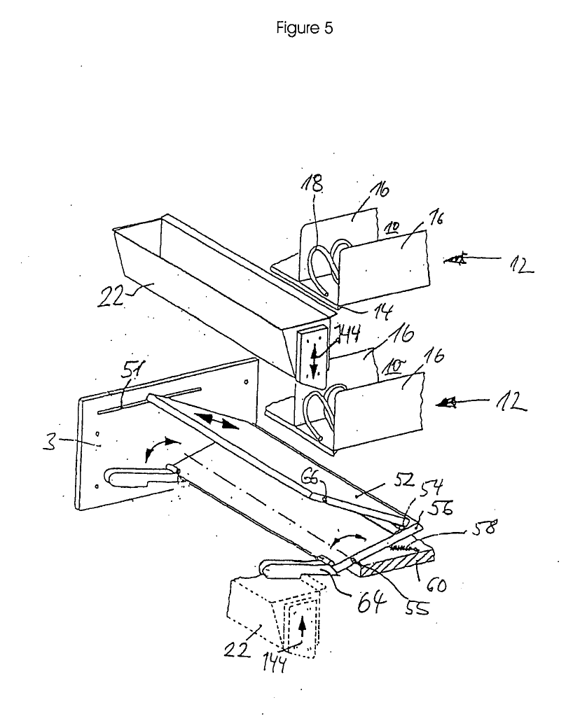

FIG. 5 shows a perspective view of the lower section in the known vending machine, with the removal tray in a transfer position,

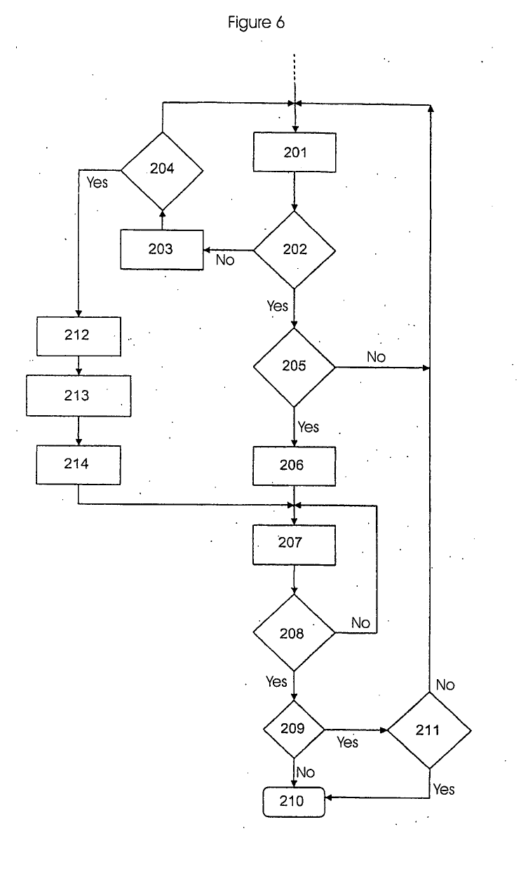

FIG. 6 shows a flow diagram in which the main steps according to one embodiment of the present invention are shown,

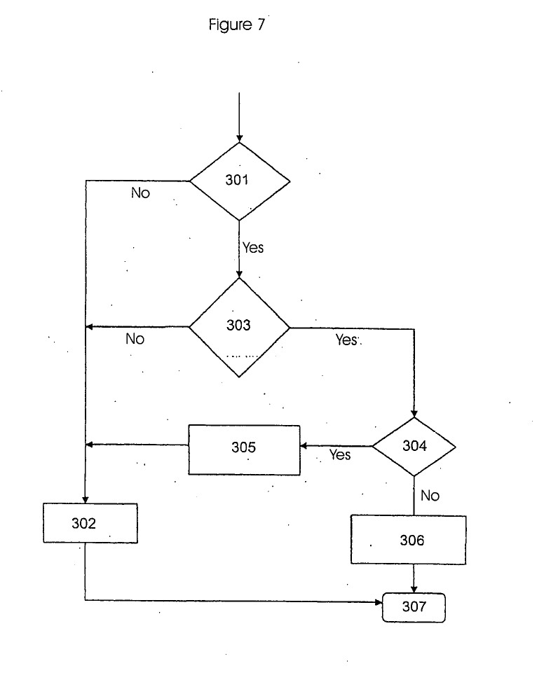

FIG. 7 shows a flow diagram of the inventive procedure applied in one embodiment of the present invention when there is a blockage.

FIG. 1 shows, in the form of a block diagram, the typical components of which a vending machine according to the invention is comprised. In the center there is an electronic control and memory unit 101, which is preferably a microprocessor-controlled electronic unit that controls, inter alia, the functions according to the invention in the vending machine. A defined number of spiral drive motors 102 corresponding to the number of merchandise dispensing options and/or merchandise compartments in the vending machine are coupled to controller 101. A transport drive motor 103 (DC geared motor) for driving the transport mechanism and which moves the removal tray up and down is likewise coupled to controller 101. The controller 101 is also coupled to a display 104 for providing feedback to the customer, and to any coin/note acceptor/dispenser device 105. In this embodiment, a position control means 106 for generating position signals is also coupled to the electronic control and memory unit 101. The position control means is preferably embodied as an infrared fork light barrier. Details will now be provided regarding the interaction of the components shown in FIG. 1, with reference to FIGS. 2-7.

The components shown in FIG. 1 are suitable, for example, for embodying a vending machine, such as that shown in a perspective sectional view in FIG. 2, in the manner of the invention. The vending machine shown in FIG. 2 has a front wall 2 that closes the front of the vending machine. On the inside, the vending machine has a merchandise dispensing region 6 in a lower portion. A merchandise storage section is disposed above the merchandise dispensing region. A plurality of merchandise compartment groups 12 are arranged one above the other in the merchandise storage section, each group having a plurality of merchandise compartments 10 arranged one adjacent the other. Two spirals 18 are arranged in parallel inside each merchandise compartment 10. These spirals are provided to receive items of merchandise between the turns of the spirals, including any items that are sensitive to impact. The spirals 18 rotate in opposite directions to each other and include the spiral drive motors 102 pursuant to FIG. 1 (the spiral drive motors 102 are not shown in FIG. 2), which can be actuated to feed items of merchandise by turning the spirals 18 containing the items of merchandise. The adjacent merchandise compartments 10 are separated from each other by partition walls 16. Merchandise compartments 10 of the group of merchandise compartments 12 have a common floor, on the front edge of which an edge profile 14 is disposed.

The front wall 2 of the vending machine is configured as a door which is attached to a rigid side wall (not shown) of the vending machine. The front wall 2 or door has a viewing window 4 that provides a viewer with a clear external view of the groups of merchandise compartments 12 in the merchandise storage section. In a section below viewing window 4, front wall 2 has a removal opening 8 from which the items of merchandise can be taken after they have been sold and dispensed from the merchandise dispensing region 6 of the vending machine. The removal opening 8 is provided with a removal flap 7 that is hingedly mounted on the inner surface of front wall 2 above removal opening 8 and which can be pivoted into the inside the vending machine.

The front wall 2 is spaced apart from the groups of merchandise compartments 12. The region between the front wall 2 and the groups of merchandise compartments 12 forms a transport space in which a transport mechanism 20 is disposed that is provided for transporting the items of merchandise pushed by spirals 18 over the edge profile 14 of the floor to a removal position in the dispensing region 6.

The transport mechanism 20 contains transmission elements 24 embodied as endless toothed belts. The transmission elements 24 run over upper and lower deflection elements 26 and drive elements 28, which are each embodied as rotatably mounted rollers. The transport mechanism 20 also includes a drive shaft 30 for driving drive elements 28 and a transport drive motor 103 with a gearbox 32 for driving drive shaft 30. A removal tray 22 is fixed to transmission elements 24 by means of fixing elements 44. The length of removal tray 22 corresponds to the width of the group of merchandise compartments 12. Removal tray 22 is horizontally arranged with its longitudinal axis parallel to edge profiles 14 and can be moved in a vertical direction by means of transmission elements 24.

FIG. 3 shows a sectional detail of a transmission element 24 of the transport mechanism 20. Transmission element 24 is embodied as a toothed belt. A fixing element 44 is disposed on each end of removal tray 22. Fixing element 44 has a parallelepiped shape, for example. Fixing element 44 consists of two jaws that likewise have a parallelepiped shape. A section of the toothed belt is guided between opposite surfaces of the jaws. The jaws are pressed against each other and fastened to the toothed belt. Fixing element 44 is slidably received in a guide rail 46 that is vertically disposed inside the vending machine.

FIGS. 4 and 5 show the merchandise dispensing region and a lower portion of the merchandise storage section of the vending machine. The merchandise dispensing region 6 is located below the merchandise storage section comprising the groups of merchandise compartments 12, which include the merchandise compartments 10 with spiral(s) 18, the compartments being separated from each other by partition walls 16.

The merchandise dispensing region 6 can be separated from the merchandise storage section by a blocking flap 50. Blocking flap 50 is located behind the removal opening 8 (not shown in FIGS. 4 and 5). Removal flap 50 comprises two elongate, plate-shaped flap sections 52, 56. Flap sections 52, 56 are pivotably arranged with respect to each other in the axial direction by means of a first hinge means 54. The hinge axis is horizontal.

By means of a second hinge means 55, blocking flap 50 is pivotably attached to a horizontal partition 60 mounted inside the vending machine. The pivot axis of the second hinge means 55 runs parallel to the pivot axis of the first hinge means 54. A spring 58 is fixed to partition 60, the spring being connected to the second flap section 56 and biasing the blocking flap 50 pivotably mounted on partition 60 against partition 60.

Blocking flap 50 and partition 60 are bordered by two vertical side walls 3 which are spaced apart from each other by the length of the first and second flap sections 52, 56 and partition 60. A guide groove 51 is embodied in one section of side wall 3. The first flap section 52 has a guide pin 66 on each opposite end, said guide pin 66 engaging with guide groove 51 and positively guiding blocking flap 50 during a pivoting movement.

Two actuating levers 64 are pivotably attached in a spaced-apart manner to the foot of the second flap section 56. A third hinge means 62 is used as fixing means, said hinge means 62 being attached opposite the second hinge means 55 to the surface having the first hinge means 54. The pivot axis of the third hinge means 62 runs parallel to the pivot axis of hinge means 54, 55. Actuating levers 64 are configured with a stop member and form an angle of not quite 180 degrees with the second flap section 56 when in a stop position. For example, when the second flap section 56 adopts a vertical position—as shown in FIG. 4—, actuating levers 64 below the second flap section 56 slope forwards a little from a perpendicular plane.

Blocks 144 are mounted on the ends of removal tray 22. In FIG. 4, removal tray 22 is located in a removal position in the merchandise dispensing region 6 of the vending machine. Blocks 144 arranged on the ends of removal tray 22 abut the actuating levers 64, and blocking flap 50 is pivoted against the biasing force of spring 58 into a closed position. When blocking flap 50 is in this position, the merchandise storage section of the vending machine located above blocking flap 50 is closed off from merchandise dispensing region 6. Reaching through removal opening 8 (not shown in FIGS. 4 and 5) and through merchandise dispensing region 6 into the merchandise storage section is prevented by blocking flap 50 being in the closed position. The merchandise storage section is also thermally sealed from the merchandise dispensing region 6. The merchandise storage section is therefore easy to cool, in order to keep the merchandise fresh.

In FIG. 5, removal tray 22 has been moved vertically upward from the removal position into a desired position. In the desired position, a section of the upper edge of removal tray 22 is located approximately in front of profile 14 of the floor of the group of merchandise compartments 12. Due to the biasing force of spring 58, blocking flap 50 is folded down against partition 60 and is in a release position in which the transport space for moving the removal tray is cleared. In this position, actuating levers 64 are pivoted downward in an approximately horizontal position. The free ends of actuating levers 64 project forward to a position just behind removal flap 7 (not shown in FIGS. 3 and 4), blocking removal flap 7 from any pivoting movement and thus acting as a locking means for removal flap 7 when removal tray 22 has been moved out of the removal position.

When, in response to a request command from the control and memory unit 101 (shown in FIG. 1) to the spiral drive motor 102, the latter drives spirals 18 of a merchandise compartment, an item of merchandise (not shown) located between the two frontmost turns of spirals 18 is pushed forward and slides from the floor of merchandise compartment 10 over the upper edge of removal tray 22 into removal tray 22. Due to the small difference in height between the upper edge and the bottom of removal tray 22, the item of merchandise does not suffer any damage during its sliding and falling movement. The removal tray 22 containing the item of merchandise is moved vertically downward. When crossing from the merchandise storage section into the merchandise dispensing region 6, it passes the first flap section 52, which is drawn to the rear due to the action of spring 58, which holds blocking flap 50 in the release position and biases it against partition 60. Blocks 144 on the ends of removal tray 22 press against the actuating levers 64 when removal tray 22 is lowered further into the merchandise dispensing region. When being lowered, removal tray 22 thus exerts a torque about the axis of the second hinge means 55 on blocking flap 50 via actuating levers 64 and the second flap section 56. This torque causes the second flap section 56 to be pivoted against the biasing force of spring 58 into a vertical position. The first flap section 52, which is pivotably attached to the second flap section 56 and positively guided by guide pin 66 in guide groove 51, is moved forwards into a horizontal position above removal tray 22. When the first flap section 52 is in the horizontal position and the second flap section 56 in the vertical position (cf. FIG. 4), blocking flap 50 is in the closed position.

To perform maintenance on the vending machine, removal tray 22 can be moved further downward out of the removal position into a maintenance position; in FIG. 5, a portion of the removal tray 22 is shown by broken lines in the maintenance position. In the maintenance position, removal tray 22 is located so low that blocks 144 lie below actuating levers 64, and the latter do not abut blocks 144. Blocking flap 50 is pivoted by the biasing force of spring 58 and drawn back to the rear wall of the vending machine. When maintenance of the vending machine has ended, removal tray 22 is moved back into the removal position above the maintenance position. The actuating levers 64 which are pivotably attached to the second flap section 56 are pivoted upward by the upward movement of removal tray 22. When removal tray 22 has moved to such a height that removal tray 22 clears actuating levers 64, actuating levers 64 fall back downward due to their own weight.

The inventive interaction among the components shown in FIG. 1 shall now be explained by way of example for a vending machine pursuant to FIGS. 2-5 with reference to the flow diagram in FIG. 6. FIG. 6 shows the flow diagram or logic diagram of a typical sale procedure comprising the possible procedural options in respect of the movement of removal tray 22. The requisite logic control is preferably realized as software in the electronic control and memory unit 101 of FIG. 1.

At the beginning of a sale procedure, transport drive motor 103 (e.g. a DC motor) for moving the removal tray receives a signal in step 201 to move the removal tray out of a neutral position, typically located near or in dispensing region 6 of the vending machine, in the direction of a desired position in order to receive an item of merchandise. During this movement, a check is performed in step 202 to determine whether position control means 106 is supplying a position signal. As long as no position signal has been received, a counter (or other timer) which measures duration is incremented in step 203. In step 204, a check is performed to determine whether a time limit has been exceeded. As long as no time limit has been exceeded, the removal tray is moved further in step 201 in the direction of the desired position.

If the position signal is then received by the control and memory unit 101 in step 202, a check is performed in step 205 to determine whether the desired position has already been reached. If the desired position has not yet been reached, the procedure branches back to step 201, in which transport mechanism 20 continues to be made to move the removal tray in the direction of the desired position. In step 202, another check is performed to determine whether a position signal is received, and the logic control branches back to step 201 according to the criteria already described.

If, in step 205, it is recognized that the desired position has been reached, an item of merchandise is expelled in step 206. According to the present embodiment, the corresponding spiral drive motor 102 is rendered operational for this purpose until such time as the item of merchandise has been dispensed and is then located in removal tray 22. Removal tray 22 is then moved in step 207 into the removal position. When the removal position has been reached in step 208, the sale procedure ends, and any excess money is returned, etc.

The sequence that occurs when removal tray 22 is blocked in a position, such that it cannot pass beyond a certain position that does not yet match the desired position, shall now be described. In practice, this occurs when the vending machine is badly filled, for example, which can lead to the removal tray 22 being blocked in its upward movement by items of merchandise protruding from the merchandise compartments 10. However, other reasons for a blockage are also conceivable, for example foreign matter or a dysfunctional transport mechanism.

In step 201, removal tray 22 is firstly moved in the customary manner in the direction of the desired position. In step 202, control unit 101 checks for the position signal from the position control means 106. During this check, in step 293, a counter disposed in the electronic memory and control unit 101 and operating as a timer is incremented. Based on this timing device, control unit 101 determines in step 204 whether a predefined time limit has been exceeded without a further position signal occurring in step 202. If the time limit has been exceeded, the logic control branches to step 212.

In step 212, the electronic memory and control unit 101 stores the most recently determined position of removal tray 22 or, alternatively, the position that has not yet been reached as the blockage position. In step 213, a counter for the number of attempts to reach the desired position is raised by one. In step 214, a blockage flag stating that a blockage is present is also set.

Removal tray 22 is then moved, in step 207, back down in the direction of the removal position. Some other neutral position may be chosen instead of the removal position. A check in performed in step 208 to determine whether the latter position has been reached. If not, the logic control branches to step 207 again and removal tray 22 is moved further downward. Once the removal position (or other neutral position) has been reached, a check is performed in step 209 to determine whether a blockage was present. This is done by checking the blockage flag in step 209. If the blockage flag has been set, the logic control branches to step 211.

In step 211, a check is performed on the number of attempts made to reach the desired position. As long as a predefined number of attempts—for example, three attempts—has not been reached, the logic control branches to step 201. In step 201, the removal tray is again moved upward from the removal position or neutral position. As described in the foregoing, an attempt is again made to reach the desired position with removal tray 22. If the time limit in step 204 is exceeded yet again before a further position signal is received, the blockage position is stored in step 212 and the number of attempts is increased by one in step 213, and the blockage flag is set in step 214.

In steps 207 and 208, removal tray 22 is returned to the removal position or neutral position, and in step 209 a check is performed to determine whether a blockage was present. If this is the case, the number of attempts to reach the desired position is checked again. If the number of attempts finally matches the predefined number of attempts, the sale procedure is terminated in step 210. The customer then receives a message on display 104 that he can either change his choice of merchandise or be refunded his money. The electronic control and memory unit 101 according to the invention can then include the blockage position in the control procedure and in future sale procedures apply a special handling routine as described in the following with reference to FIG. 7.

As part of the special handling routine, the flow diagram for which is shown in FIG. 7, the electronic control and memory unit 101 checks in step 301 whether a blockage position has been stored. If this is not the case, a normal sales routine is performed in step 302 and the sale procedure is terminated in step 307. However, if it is established in step 301 that a blockage position has been stored, it is determined in the subsequent step 303 whether the merchandise requested by the customer's choice of merchandise is located in merchandise compartment 10, which cannot be reached by removal tray 22 due to the stored blockage position. As long as this is not the case, a normal sales routine is performed in step 302.

However, if the desired position for removal tray 22 is beyond the blockage position—and cannot be reached, therefore—controller 101 decides in step 304 whether a sale procedure can be carried out even when removal tray 22 is still at a distance from the desired position. This is decided, for example, on the basis of whether or not an item of merchandise from a higher section of the vending machine can also fall into removal tray 22 without the item of merchandise being damaged. When it is possible to dispense the merchandise, even though removal tray 22 has not reached the position actually desired for gentle dispensing of the merchandise, the selection is released in step 304. In step 305, the desired position for future sale procedures is replaced by a value corresponding to the blockage position (e.g. blockage position minus one, depending on the type of counter). A normal sales routine is then performed in step 302 and ended in step 307. However, if it is decided in step 304 that the choice cannot be released, the vending machine signals the termination of sale in step 306 and requests the customer to choose a different product, or to terminate the sale procedure in order for the money to be returned. The sale procedure is then ended in step 307.

1. A vending machine comprising a plurality of merchandise compartments (10) arranged one above the other, a dispensing means (18, 102) for each merchandise compartment (10), which, when activated, dispenses an item of merchandise from the respective merchandise compartment (10), at least one transport mechanism (20) that can be driven by drive means (26, 28, 30, 32, 103) and which transports the items of merchandise dispensed by the dispensing means (18) to a removal position by means of a removal tray (22), and an electronic control and memory unit (101) for controlling the transport mechanism (20) in order to move the removal tray (22) to a desired position in front of the respective activated merchandise compartment (10) to receive an item of merchandise and subsequently into the merchandise dispensing region (6) and the removal position for removal of the item of merchandise, characterized in that the electronic control and memory unit (101) is configured to detect and store a blockage position from which, before reaching the desired position, the removal tray (22) cannot be moved further in the direction of the desired position.

2. The vending machine of claim 1, characterized by position control means (106) for generating a position signal corresponding to an actual position of the removal tray (22).

3. The vending machine of claim 1 or 2, characterized in that the electronic control and memory unit (101) is configured to detect a timeout in the event that the removal tray (22) does not reach a predefined actual position when moving to the desired position.

4. The vending machine of claim 3, characterized in that the electronic control and memory unit (101) is configured to store the blockage position when the timeout has been detected.

5. The vending machine of claim 3 or 4, characterized in that the control and memory unit (101) is configured to perform at least one second attempt to move the removal tray (22) to the desired position, in the event that a timeout was detected in the respective preceding attempt.

6. The vending machine of claim 5, characterized in that the control and memory unit (101) is configured to record the number of attempts in which a timeout was detected.

7. The vending machine of claim 6, characterized in that the control and memory unit (101) is configured to end the sale procedure when a predefined number of more than two timed-out attempts to move the removal tray to the desired position has been reached.

8. The vending machine of any of the preceding claims, characterized in that the control and memory unit (101) is configured to take into account on a second sale attempt the blockage position detected and stored during a first sale attempt, by no longer offering merchandise from the activated merchandise compartment (10) for sale at a corresponding desired position of the removal tray (22) that cannot be reached.

9. The vending machine of any of claims 1 to 7, characterized in that the electronic control and memory unit (101) is configured to take into account on a second sale attempt the blockage position detected and stored during a first sale attempt, by offering merchandise from the activated merchandise compartment (10) for sale at a corresponding desired position of the removal tray (22) that cannot be reached only on condition that the item of merchandise can be transferred from the activated merchandise compartment (10) to the removal tray (22) despite the blockage.

10. A vending machine according to one of the preceding claims, characterized in that a plurality of merchandise compartments (10) are each arranged adjacent each other such that said merchandise compartments (10) form a horizontal group of merchandise compartments (12), that a plurality of such groups of merchandise compartments (12) are arranged spaced apart one above the other and that the removal tray (22) extends across the entire horizontal width of a group of merchandise compartments (12).

11. A method for operating a vending machine comprising a plurality of merchandise compartments (10) arranged one above the other, a dispensing means (18, 102) for each merchandise compartment (10) which, when activated, dispenses an item of merchandise from the respective merchandise compartment (10), at least one transport mechanism (20) that transports the items of merchandise dispensed by the dispensing means (18) to a removal position by means of a removal tray (22), and an electronic control and memory unit (101) for controlling the transport mechanism (20) in order to move the removal tray (22) to a desired position in front of the respective activated merchandise compartment (10) to receive an item of merchandise, and subsequently into the merchandise dispensing region (6) and the removal position for removal of the item of merchandise, characterized by the step:
detecting and storing a blockage position from which, before reaching the desired position, the removal tray (22) cannot be moved further in the direction of the desired position.

12. The method of claim 11, characterized by the step:
generating a position signal corresponding to an actual position of the removal tray (22).

13. The method of claim 11 or 12, characterized by the step:
detecting a timeout in the event that the removal tray (22) does not reach a predefined actual position when moving to the desired position.

14. The method of claim 13, characterized by the steps:
performing an additional attempt to move the removal tray (22) to the desired position when a timeout was detected in the respective preceding attempt,
detecting the number of attempts in which a timeout was detected, and
ending the sale procedure when a predefined number of more than two timed-out attempts has been reached.

15. The method of any of claims 11 to 14, characterized by the steps:
storing the blockage position detected in a first sale attempt for a second subsequent sale attempt, and
displaying that the items of merchandise from an activated merchandise compartment (10) cannot be sold to a corresponding desired but unreachable position of the removal tray (22) predetermined on the basis of the stored blockage position.

16. The method of any of claims 11 to 14, characterized by the steps:
storing the blockage position detected in a first sale attempt for at least one second subsequent sale attempt, and
dispensing merchandise also from an activated merchandise compartment (10) to a corresponding desired but unreachable position of the removal tray (22) on the basis of the stored blockage position, if the item of merchandise can be transferred from the activated merchandise compartment (10) to the removal tray (22) despite the blockage.
